(19) United States
(12) Patent Application Publication
(10) Pub. No.: US 2015/0042793 A1
(43) Pub. Date: Feb. 12, 2015

(54) Celestial Compass with sky polarization

(71) Applicants: Mikhail Belenkii, San Diego, CA (US); Lawrence Sverdrup, Poway, CA (US); Vladimir Kolinko, San Diego, CA (US)

(72) Inventors: Mikhail Belenkii, San Diego, CA (US); Lawrence Sverdrup, Poway, CA (US); Vladimir Kolinko, San Diego, CA (US)

(73) Assignee: Trex Enterprises Corporation

(21) Appl. No.: 13/987,604

(22) Filed: Aug. 12, 2013

(51) Int. Cl. G01C 21/02; G01S 3/786

(52) U.S. Cl. CPC G01C 21/02; G01S 3/7864; G01S 3/7861; G01S 3/7867
USPC 348/143

(57) ABSTRACT

A celestial compass with a sky polarization feature. The celestial compass includes an inclinometer, a camera system for imaging at least one celestial object and a processor programmed with a celestial catalog providing known positions at specific times of at least one celestial object and algorithms for automatically calculating target direction information based on the inclination of the system as measured by the inclinometer and the known positions of at least one celestial object as provided by the celestial catalog and as imaged by the camera. Preferred embodiments include backup components to determine direction based on the polarization of the sky when celestial objects are not visible.

### CROSS REFERENCE TO RELATED APPLICATIONS

This application is a continuation in part of patent applications Ser. No. 13/373,009 filed Nov. 1, 2011 which was a CIP of Ser. No. 12/283,785, Portable Celestial Compass filed Sep. 15, 2008, Ser. No. 12/319,651, Angles Only Navigation System filed Jan. 8, 2008 and Ser. No. 12/583,776 Miniature Celestial Direction Detector filed Aug. 25, 2009 and Ser. No. 12 586,813 filed Sep. 28, 2009, each of which are incorporated herein by reference. This application also claims the benefit of Provisional Application Ser. No. 61/742,448, filed Aug. 10, 2013.

### FEDERAL SUPPORTED RESEARCH

The present invention was made in the course of work under Marine Corps contract number M67854-12-C-6501 and the United States Government had rights in the invention.

### FIELD OF INVENTION

The present invention relates to direction detection systems, especially to such systems designed for use in determination of precise locations of targets.

### BACKGROUND OF THE INVENTION

### Sky Charts

The position of celestial objects at any time at any place on earth is known with extremely high accuracy. These celestial objects include all recognizable stars and planets, the sun and the moon. Celestial objects also include visible man-made satellites. Accurate positioning of the celestial objects depends only on knowledge of the latitude and longitude positions and on the date and the time to within about 1 to 3 seconds of observation. Latitude and longitude generally can be determined easily with precision of less than one meter with global positioning equipment. Computer programs with astronomical algorithms are available that can be used to calculate the positions of any of these celestial objects at any time for any position on or near the surface of the earth. Star pattern recognition computer programs are available in the prior art. These computer programs are described in several good text books including Astronomical Algorithms by Jean Meeus, published by Willmann-Bell with offices in Richmond Va. Techniques for using the programs to determine the positions of the celestial objects are clearly described in this reference. Programs such as these are used to provide planetarium programs such as “The Sky” available from Software Bisque and “Guide” available from Project Pluto.

### Fisheye Lenses

Fisheye lenses are lenses with a highly curved protruding front that enables it to cover a solid angle of about 180 degrees. The lenses provide a circular image with barrel distortion.

### MEMS Inclinometers

Vertical at the observation position can easily be found by using an inclinometer. Tiny MEMS type inclinometers (such as Analog Devices ADIS 162097) with accuracies better than 2 milliradians are available from suppliers such as Jewell Instruments with offices in Manchester, N.H. and Digikey with offices in Thief River Falls Minn. The cost of these inclinometers typically is in the range of about $60.

### Digital Magnetic Compasses

Magnetic compasses are typically accurate to only one degree, and the presence of steel or other local disturbances will often reduce accuracy of the magnetic compasses to several degrees or render them useless. Therefore, if positioning of a target depends on the use of a magnetic compass, substantial position errors could likely result. In the case of military operations, the accuracy of current and future fire support systems strongly depends on the errors in target coordinates called target location error. In order to reduce collateral damage and improve target lethality, a target locator error on the order, of less than, 10 meters at 5 km range is needed. Current target location technology does not meet this standard. The main source of error is magnetic compasses. Commonly a ground-based observer determines target coordinates using a laser rangefinder, GPS receiver, and magnetic compass. Under ideal magnetic conditions the measurement error (usually referred to as an “RMS error” of a magnetic compass is typically 10-17 milliradians. This corresponds to the locator error of 50-85 meters at a 5 km range. In many situations knowledge of the true azimuth to a target with precision of much better than 1 degree (about 17.45 milliradians) is needed. Also magnetic compasses are highly sensitive to random errors caused by weakly magnetic disturbances (e.g. vehicles, buildings, power lines etc.) and local variations in the earth's geo-magnetic field. These error sources are random and cannot be accurately calibrated and modeled to subtract out. A large magnetic disturbance from hard or soft iron effects can result in target accuracy errors of up to 30 to 60 degrees.

### Attitude Heading and Reference Systems

Attitude heading reference systems (AHRSs) are 3-axis sensors that provide heading, attitude and yaw information for aircraft and other systems and components. AHRSs are designed to replace traditional mechanical gyroscopic flight instruments and provide superior reliability and accuracy. These systems consist of either solid-state or MEMS gyroscopes, accelerometers and magnetometers on all three axes. Some of these systems use GPS receivers to improve long-term stability of the gyroscopes. A Kalman filter is typically used to compute solutions from these multiple sources. AHRSs differ from traditional inertial navigation systems (INSs) by attempting to estimate only attitude (e.g. pitch, roll) states, rather than attitude, position and velocity as is the case with an INS.

AHRSs have proven themselves to be highly reliable and are in common use in commercial and business aircraft. Recent advances in MEMS manufacturing have brought the price of Federal Aviation Administration certified AHRS's down to below $15,000.

Although gyroscopes are used to measure changes in orientation, without the absolute references from accelerometers and magnetometers the system accuracy quickly degrades. As such, when there are extended periods of interferences or errors introduced into the sensing of gravity or magnetic field performance of the system can be seriously compromised. As a general reference, gravity is almost perfect—it is a constant force that is not influenced dramatically by anything. The most difficult error introduced in sensing gravity is the acceleration added during movements. Each time the system or component is moved, acceleration is sensed, thus creating a potential for error. This however is easily mitigated by applying algorithms to the data that filter out such high frequency accelerations, resulting in a very accurate means of determining the vector of gravity. Note that this information is used only for initial setup and system corrections, and is not needed for real-time tracking of orientation. Magnetic field disturbances are much more difficult to deal with.

### Sky Polarization

It is known that in general the sky light is polarized tangential to a circle centered in the sun and maximum polarization is found at ninety degrees from the circle. Therefore, with the sun close to the zenith the sky light will be polarized horizontally along the entire horizon. On the other hand, when the sun is setting in the West, the sky will be maximally polarized along the meridian and thus vertically at the due North and South. Toward the zenith just after sunset (or before sunrise) the degree of polarization of the sky light can reach its maximum of about 75 percent on very clear days,

Numerous creatures utilize the sky polarization compass for navigation, with new examples being continually discovered. Desert ants cannot leave a pheromone trail because this biochemical signal is subject to evaporation. Instead they use a sky polarization compass.ⁱ Bees also use a sky polarization compass. Migratory birds utilize the earth's magnetic field, the stars and the sun as compasses, but the sky polarization compass is utilized to calibrate all of the other compasses. Dung beetles have been shown to use a sky polarization compass at night where sky illumination is provided by the moon. The ability to use polarization vision in the animal kingdom is probably much more widespread than we realize.

It is known that some animals use green light, many use blue light, but most use near ultraviolet light for their sky polarization compass. The reason for this is apparently that in adverse conditions such as complete overcast, the sky polarization signal is largest in the UV. In clear conditions, it is largest in the blue/green spectral region.

The first known sky polarization compass was built in the 1940's as a single pixel device measuring the sky at zenith. It has been reported that the Scandinavian airlines SAS used a “single-zenith-pixel” sky polarization compass during polar flights in the 1950's. In the late 1990s a Swiss group mimicked desert ant navigation, building a robot that navigated using a single zenith pixel sky polarization compass.

A device known variously as the Pfund compass, the Kollsman Sky Compass, or simply as the “twilight” compass, was utilized by the US Navy in 1948. It determined the azimuth of the sun when the sun was not visible by examining the polarization of the sky at zenith. This proved to be extremely valuable in the far north, where magnetic compasses are minimally useful, and twilight conditions can persist for long durations, during which both sun and stars are not visible and therefore useful for navigation. The accuracy was reported to be about 0.5°.

A version of a sky polarization compass that utilized sky light at zenith was developed at the National Bureau of Standards and published in the Review of Scientific Instruments in 1949. The accuracy was estimated to be approximately 1°, decreasing if the zenith is obscured by clouds.

### The Need

What is needed is a non-magnetic compass that can operate day and night, and in most weather conditions, and does not require an un-obscured line of sight to the sun or moon.

### SUMMARY OF THE INVENTION

The present invention provides a celestial compass including a sky polarization feature. The celestial compass includes an inclinometer, a camera system for imaging at least one celestial object and a processor programmed with a celestial catalog providing known positions at specific times of at least one celestial object and algorithms for automatically calculating target direction information based on the inclination of the system as measured by the inclinometer and the known positions of at least one celestial object as provided by the celestial catalog and as imaged by the camera. Preferred embodiments include backup components to determine direction based on the polarization of the sky when celestial objects are not visible.

In referred embodiments the camera system includes a telecentric fisheye lens that produces an image on the sensor located at or near the focal plane which remains spatially constant within sub-micron accuracies despite thermally produced changes in the focus of the lens. These embodiments may also include a movable filter unit to increase greatly the dynamic range of the kit and permit day and night operation with the single lens. In preferred embodiments the filter unit includes an electromagnetic switch. In other embodiments the switch is a manual switch or a motor-driven switch. The filter in preferred embodiments is comprised of a thin Mylar film coated with a special partially reflective coating. With the increased dynamic range of the camera the moon can be imaged during the period after sunset and before sunrise when stars are not visible. The compass permits imaging of the moon and sun through light cloud cover. Other preferred embodiments can include an inertial navigation sensor including a magnetic compass and a memory-based optical navigation system that permits continued operation on cloudy days and even in certain in-door environments. In some preferred embodiments calibration components may be provided in a separate module to minimize the size and weight of the compass.

These embodiments use celestial sighting of the sun, moon or stars to provide absolute azimuth measurements relative to absolute north. In preferred embodiments the inclinometer is an internal MEMS inclinometer providing measurements relative to the local vertical (gravity based). Celestial observations are combined with known observer position and time, which can normally be obtained from a GPS receiver, in order to compute the absolute azimuth pointing of the device.

The present invention has the following principal advantages over the similar prior art device discussed in the background section:
Nonmagnetic compass
No performance degradation over time (no drift)
Compact
No moving parts (other than the filter)
Lightweight
Low power
Low cost
RMS azimuth measurement error is about 1 mil
Low production cost
Allow for operation in urban environments, near vehicles and power lines, and while wearing body armor
Near zero startup time (azimuth measurement in about 2 seconds)

### BRIEF DESCRIPTION OF THE DRAWINGS

FIG. 1 illustrates a preferred embodiment of the present invention where the celestial compass is an accessory of a far target location (FTL) system.

FIG. 2 is a prospective view of a preferred embodiment of the present invention.

FIG. 3 is a cross sectional drawing showing features of the FIG. 2 embodiment.

FIG. 4 is an exploded view drawing of the FIG. 2 embodiment.

FIG. 5 is a breakaway drawing of the electronic filter mechanism of the preferred embodiment.

FIG. 6 is a drawing showing the lens elements of a telecentric fisheye lens specially designed for this preferred embodiment of the present invention.

FIG. 7 is a cross sectional drawing of a portion of the fisheye lens showing detailed features of the lens.

FIG. 8 is a block diagram showing electronic components of the above preferred embodiment of the present invention.

FIG. 9 is a set of specifications for the telecentric fisheye lens system.

FIG. 10 shows an experimental setup for testing sky polarization components.

FIG. 11 shows test results of the sky polarization tests.

### DETAILED DESCRIPTION OF PREFERRED EMBODIMENTS

### First Preferred Embodiment

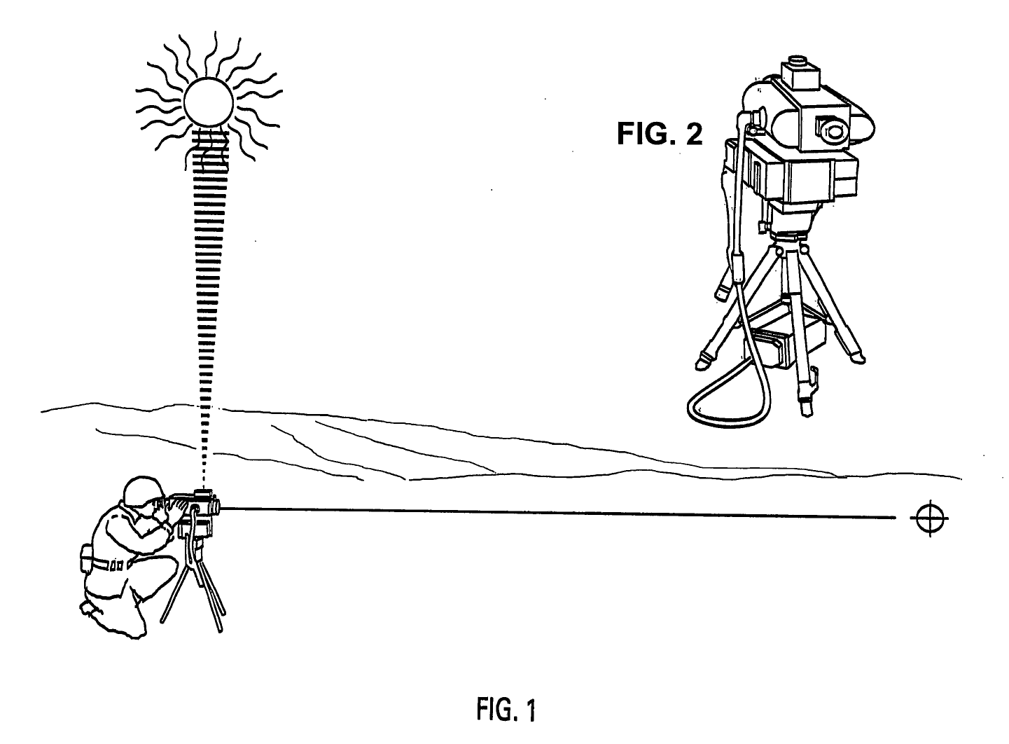

A first preferred embodiment of the present invention can be described by reference to FIGS. 1 through 9. FIG. 1 shows a celestial compass as a component of a far away target location system mounted on a tripod. The celestial compass has imaged the sun and with information from an inclinometer (not shown), the correct date and time and the correct geographic position of the laser finder, the processor within the celestial compass has determined the orientation of a telescope in the far target location system and with the timing of a return infrared laser pulse from target has determined the exact geographic position of the target.

A preferred module of the celestial compass of the present invention is shown in detail in FIGS. 2 through 8. FIG. 2 is a prospective view of the celestial compass. Shown in the drawings is celestial compass, with a single fisheye lens assembly 14 mounted on circuit board 16. Also shown is inclinometer unit 18 which is an off-the-shelf unit, Model ADIS 16209 furnished by Analog Devices with offices in Norwood Mass.

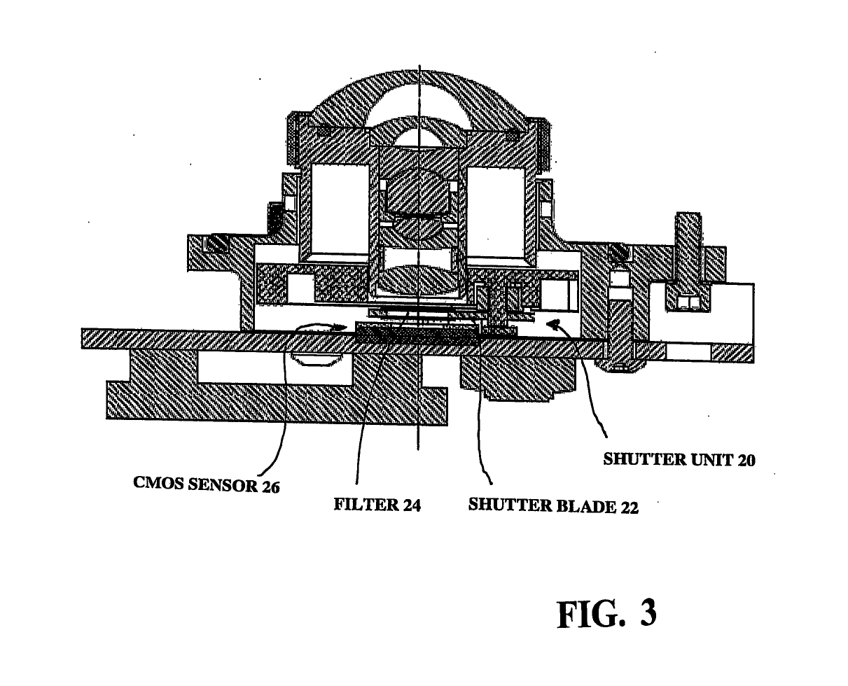

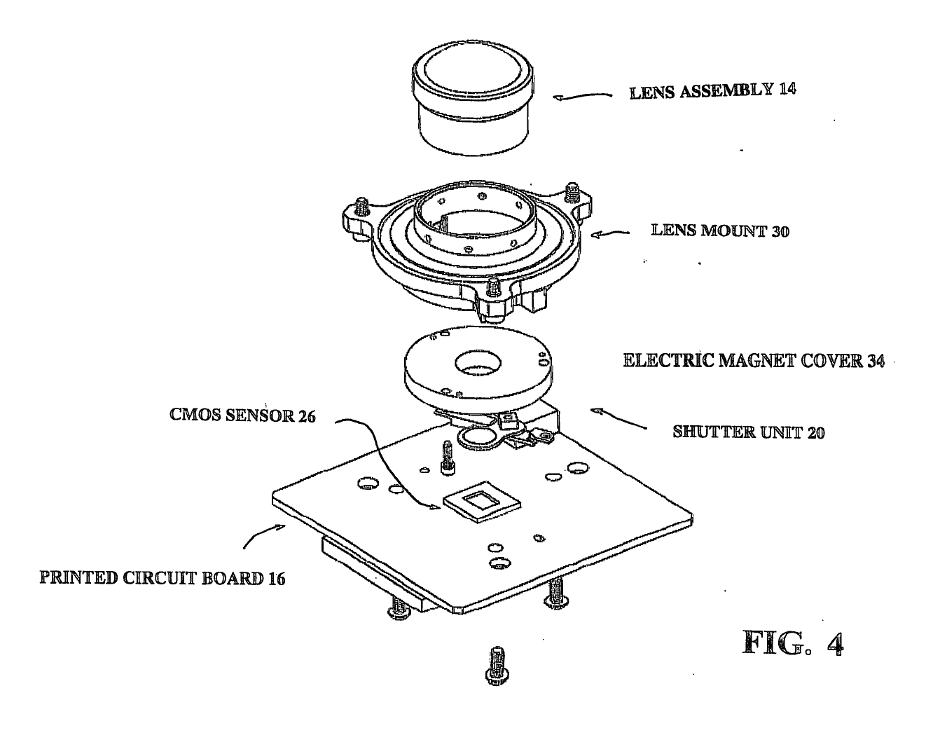

FIG. 3 is a cross sectional drawing showing some additional features of this preferred embodiment. This celestial compass utilizes a single lens and a single CMOS sensor for imaging the sun during daytime and for imaging the moon and stars during the nighttime. Since brightness levels during the day are many orders of magnitude greater during the day as compared to night, applicants have designed an automatic shutter-filter system permitting the same lens-sensor unit to be used during the day and at night. The preferred shutter unit is shown at 20 in the FIG. 3 drawing. The shutter blade is shown at 22, the filter is shown at 24 and the CMOS sensor is shown at 26. The CMOS sensor is a 5 mega pixel CMOS sensor Model No. MT9P031 provided by Aptina with offices in San Jose, Calif. FIG. 4, which is an exploded view drawing, shows additional details of the celestial compass including lens assembly 14, lens mount 30, shutter unit 20 and shutter permanent magnetic cover 32. Under the cover (not shown is an electric magnet in the form of a circularly-shaped coil. The CMOS sensor is shown at 26. These components are mounted on circuit board 16.

### Shutter-Filter

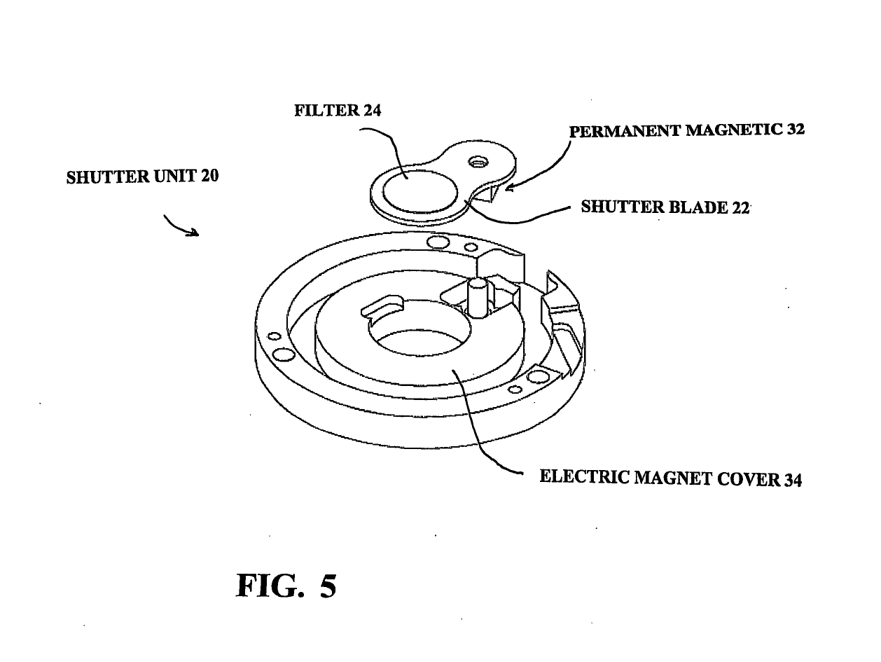

The shutter-filter is a modified version of an off-the-shelf shutter available from Uniblitz with offices in Osborne, Wash. The shutter was converted to an “in or out” filter. This shutter-filter includes a small permanent magnet shown at 32 in FIG. 5 that is positioned within a break in the circularly-shaped coil of the electro magnet. The direction of current flow through the coil of the electromagnet determines the position of filter blade 24. A reversal of current in the coil changes the orientation of the magnet and the shutter blade by 180 degrees. Current flow in a first direction orients the filter above CMOS sensor 26 for imaging the sun during daytime operation of the celestial compass and current flow in the opposite direction orients the filter away from the sensor for nighttime operation for imaging the moon or stars. The filter blade is held in place by friction if no current is flowing in the coil. So current is required only when changing the filter position. The filter itself is a thin film filter on a polyester (preferably Mylar®) substrate providing 10⁶ blocking.

### Telecentric Lens

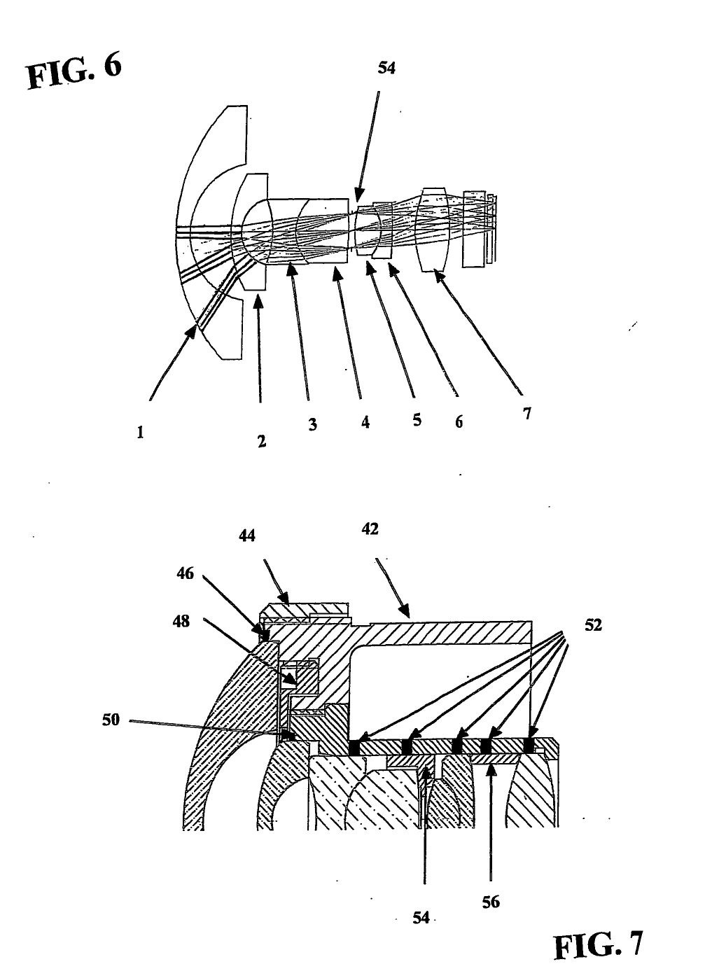

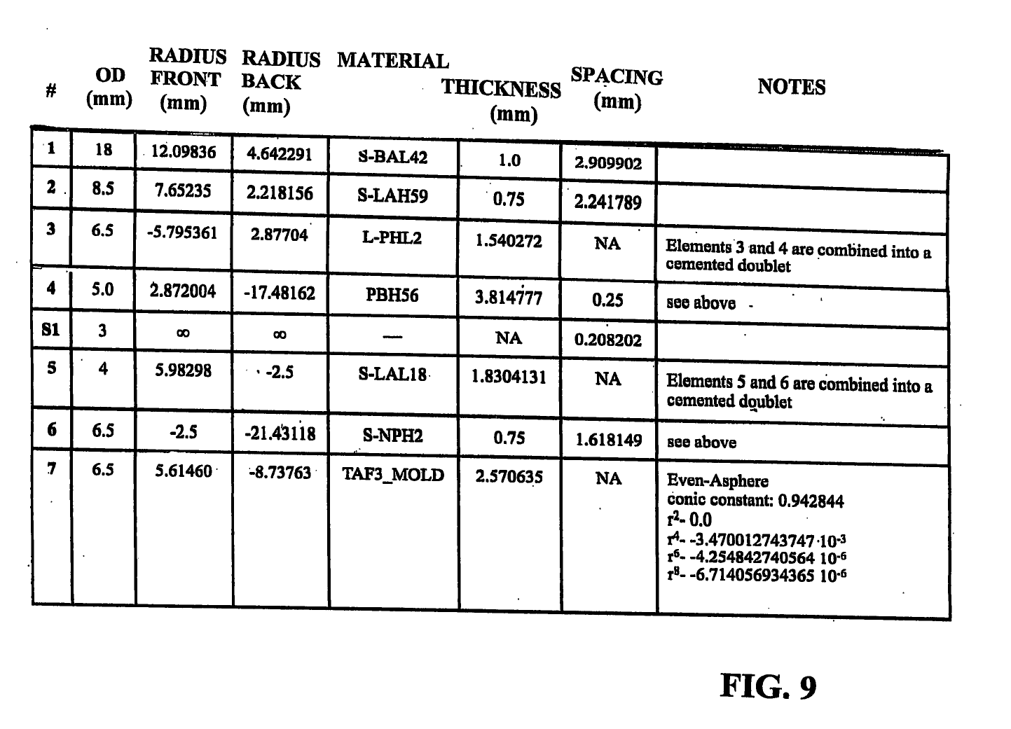

FIGS. 6 and 7 are drawings of telecentric fisheye lens utilized in the preferred embodiment of the present invention. The lens unit consists of seven optical elements shown as elements 1 through 7 in FIG. 6. The mechanical details of the layout are shown in the cross sectin drawing of FIG. 7. It consists of a single lens tube with a varying diameter. The inner diameter of the tube at each axial position matches the diameter of the lens elements and spacers that it contains. An integral skirt is part of the lens mounting structure and is used to attach the lens to an outer structure. Shown in FIG. 7 are lens mount structure 42 to hold the lens elements, a threaded retained ring 44 for holding lens element 1 and to preload in compression all subsequent lens elements, a threaded retainer ring 48 for holding lens element 2, several holes 52 in lens mount 42 for permitting injection of adhesive to fix lens elements 3-7 and their associated spacers, spacer—optical stop 54 hole 46 for adhesive for fixing lens element 1 and spacer 56 for setting the space between lens elements 6 and 7. Two sets of cemented doublets are constructed using lens elements 3&4 and 5&6 as shown in FIGS. 6 and 7. The specifications for the optical elements are found in the table in FIG. 9. Lens element 1 is held in place with retaining ring 44 which compresses the element against a ledge in the lens mount. In order to insure mechanical stability each element of the lens and each spacer is attached to the lens tube by way of an adhesive. The preferred adhesive is a non-outgassing room temperature volcanizing (RTV) silicone. For elements 1 and 2 the adhesive is applied in a 360° ring around the lens element. For elements 3-7 and the spacers around these elements as pictured in FIG. 7. The lens mount structure 42 has a series of holes 52 in it by which the adhesive may be injected as described above. The process of delivering the adhesive should insure that the adhesive contacts the side of the lens element or spacer that is radially in line with, and fill the entire hole. Four adhesive holes are distributed at 90° increments at each axial hole position. In order to facilitate applying the adhesive into the holes in the lens tube corresponding holes are position radially in the skirt structure. These allow a hollow adhesive dispensing tube to access the inner holes. To insure stability over a wide temperature range the housing structure, retaining rings, and lens spacers are made of titanium.

### Electronic Components

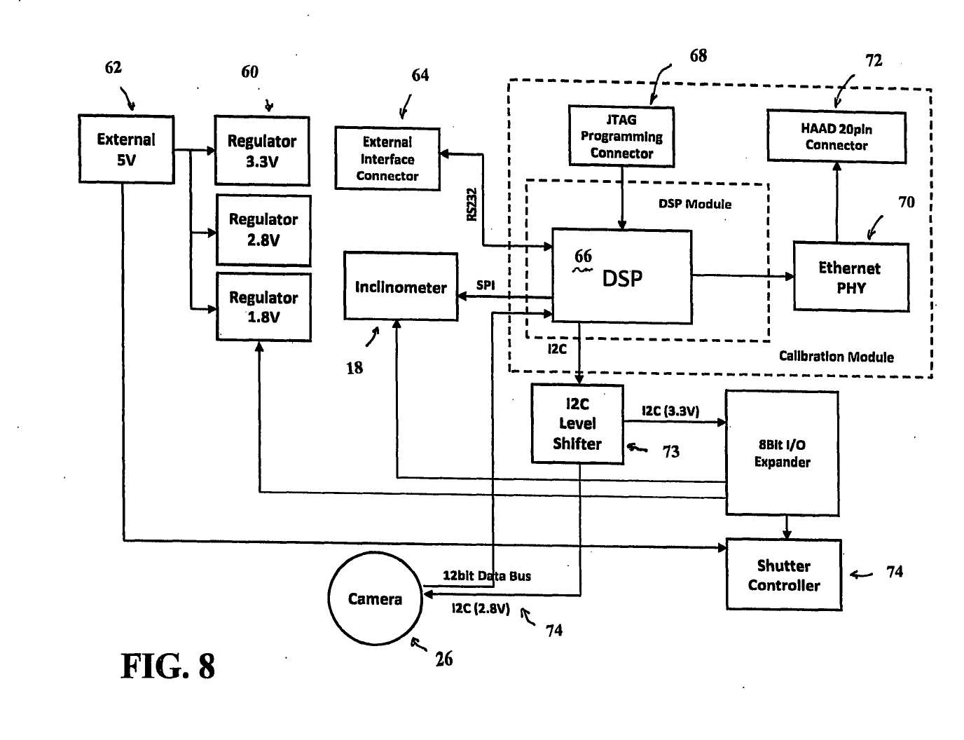

FIG. 8 is a block diagram showing important features of the electronic components of the above preferred embodiment of the present invention. These components include a set of voltage regulators 60 supplied by and external 5 volt source 62 and an external interface connector 64 in communication with digital signal processor 66 which is a DSP module (Model Backfin 537) supplied by Analog Devices with offices in Norwood, Mass. The processor is programmed and de-bugged with JTAG interface 68. The output of DSP 66 is an input to an Ethernet PHY chip 70 (Model KS8721BLI) supplied by Micrel Inc. with offices in San Jose, Calif. and a 20 pin connector 72 which provides for a connection with a simulator an a image display monitor (not shown). The DPS module 66 is also in communication with CMOS sensor 26 via an I2C level shifter 73 and a 12 bit Data Bus as shown in FIG. 8. And the module 66 is also in communication with shutter controller 74 and inclinometer 18 through an 8 Bit I/O expander as shown in the drawing. The inclinometer is a small high accuracy, dual-axis digital inclinometer and accelerometer Model ADIS 16209 supplied by Analog Devices with offices in Norwood, Mass.

### Process for Converting Celestial Data Into Target Direction

To determine the accurate location of a small celestial target relative to the camera requires only a centroid measurement. To determine the accurate celestial location of the sun or moon requires finding the edges of the target and then calculating the true center based on the size and shape of the target at the time of the observation. The software as indicated above must correct for the distortion of the fisheye lens while also converting image data into astronomical coordinates, preferably elevation, bank and azimuth.

Outline of basic daytime algorithm processing steps:
1) Measure sun azimuth and zenith on the fisheye where radius to center is proportional to the zenith angle and azimuth is the angle between column offset and row offset from the center.
2) Mathematically rotate azimuth and zenith angle (small angle approximation) from sensor/fisheye frame to inclinometer frame (i.e. calibrate by determining fisheye boresight when inclinometer is zeroed).
3) Mathematically rotate azimuth and zenith from inclinometer frame to local horizon frame with unknown azimuth offset.
4) Determine azimuth offset by taking difference between measured azimuth (step 3) and known sun position (from time and position).
5) Mathematically rotate boresight pointing in inclinometer coordinates to local horizon coordinates (with unknown azimuth) using inclinometer measurements
6) Determine absolute azimuth of boresight by azimuth offset determined in step (4).

Calibration procedure: Reverse steps (5) and (6) above while siting targets with known absolute azimuth. The calibration procedure and the procedure for absolute target azimuth and zenith (elevation) angle determination is described below.

A brief description of variable notation is summarized in Table 2. The reader should note that all coordinate rotations are based on small angle approximations. This seems reasonable since all measurements of the optical axis offset from the inclinometer z-axis (zenith pointing for zero readings) show angles less than 10 milliradians. All measurements were based on objects with inclinometer pitch and roll readings less than 5 degrees.

The sun position on the sensor is determined by a center of mass calculation. A matched filter determines the location of the sun (not necessary simply finding the peak is sufficient). The background (+camera analog to digital bias) is determined as the average of a 32×32 pixel region centered on the peak and excluding the center 16×16 pixels. A center of mass calculation is made including only those pixels in the 16×16 region with signal exceeding 5% of the peak value.

The equations assume that the image distance from the optical axis on the sensor is a linear function of the zenith angle under the following additional assumptions:
1) Inclinometer axes are orthogonal. (Presumably determined by lithography/etch on MEMS since both axes were on a single die).
2) Row/column axes combined with fisheye boresight constitute an orthogonal coordinate system.

TABLE 2
Parameter Definitions

| | |
|---|---|
| (1) | (xₛ₀, yₛ₀) = array center in pixels on sensor |
| (2) | Δx = angular pixel size |
| (3) | (αₓ, βₛ) pitch and roll of fisheye optical axis with respect to |
| | inclinometer z-axis (zenith for leveled inclinometer) |
| (4) | (φ_{b}, θ_{b}) = azimuth and zenith angle of binocular boresight |
| | in inclinometer reference frame. |

Measured Quantities

| | |
|---|---|
| (1) | (xₛ, yₛ) = sun centroid on sensor |
| (2) | (θₓ, θ_{y}) = inclinometer measured pitch and roll. |

Calculated Quantities

| | |
|---|---|
| (1) | (φₛ, θₛ) = measured sun azimuth and zenith angle in |
| | sensor/fisheye frame |
| (2) | (φₒ, θₒ) = measured sun azimuth and zenith angle in |
| | inclinometer frame |
| (3) | (φₗ, θₗ) = measured sun azimuth and zenith angle in |
| | module based local horizon coordinates |
| (4) | Δφₛᵤₙ = yaw of module based local horizon coordinates |
| | relative to true local horizon coordinates (ENU). |
| (5) | φₗ′ = absolute azimuth of the sun in local horizon |
| | coordinates (ENU) calculated based on solar ephemeris, |
| | time, and geo-location |
| (6) | φ_{bl}′ = absolute azimuth of the target |

Detailed equations are set forth below:
Coordinate system for sun position analysis.

| | |
|---|---|
| (1) | Measure sun centroid (xₛ, yₛ) |
| (2) | Azimuth and zenith angles in sensor coordinates |
| | $\begin{matrix}{ϕ}_{s} = {tan}^{- 1} ( \frac{{y}_{s} - {y}_{s 0}}{{x}_{s} - {x}_{s 0}} ) \\ {θ}_{s} = Δx \sqrt{{( {x}_{s} - {x}_{s 0} )}^{2} + {( {y}_{s} - {y}_{s 0} )}^{2}}\end{matrix}$ |
| (3) | Rotate to optical axis |
| | φₒ = φₛ + (βₛ sin φₛ + αₛ cos φₛ) cot θₛ |
| | θₒ = θₛ + (−βₛ cos φₛ + αₛ sin φₛ) |
| (4) | Rotate to local horizon using inclinometer measurements, (θₓ, θ_{y}) |
| | φₗ = φₒ − (θ_{y} sin φₒ − θₓ cos φₒ) cot θₒ |
| | φₗ = φₒ + (θ_{y} cos φₒ + θₓ sin φₒ) |
| | Δφₛᵤₙ = φₗ′ − φₗ |
| | where φₗ^{t} is the absolute azimuth of the sun. |
| (5) | Rotate boresight to local horizon coordinates |
| | φ_{bl} = φ_{b} − (θ_{y} sin φ_{b} − θₓ cos φ_{b}) cot θ_{b} |
| | θ_{bl} = θ_{b} + (θ_{y} cos φ_{b} + θₓ sin φ_{b}) |
| | φ_{bl}′ = φ_{bl} + Δφₛᵤₙ |
| | where φ_{bl}′ is the absolute azimuth of the target, and θ_{bl} is the |
| | absolute zenith angle of the target. |

### Calibration Procedures

Several calibration parameters must be determined experimentally. They are listed as the first set of items (1) through (4) in Table 2. Based on small angle approximations the systematic error in measured azimuth resulting from errors in the array center point and off zenith fisheye boresight is given by:

$$Δφ = ( {α}_{s} cos {φ}_{s} + {β}_{s} sin {φ}_{s} ) \frac{cos {θ}_{s}}{sin {θ}_{s}} - \frac{{Δθ}_{c}}{{θ}_{s}} sin ( {φ}_{s} - {φ}_{c} )$$

where Δφ is the error in the azimuth measurement, (φ_{c}, Δθ_{c}) describes the azimuth and zenith angle on the error in center position, and the remaining parameters are described in Table 2. Notice for a fixed zenith angle, errors in boresight pointing may be corrected by the errors in center location. The expression may be rewritten in terms of an effective center point and divided into sensor row and column,

$$Δ {x}_{c} = βθ \frac{cos θ}{sin θ}$$

$$Δ {y}_{c} = - αθ \frac{cos θ}{sin θ}$$

The calibration procedure takes advantage of this property by determining the center location which minimizes the azimuth error (in the least squares since) for a series of measurements at a constant (or near constant for sun) zenith angle. The procedure is repeated for several zenith angles, and the results are plotted as a function of

$$θ \frac{cos θ}{sin θ} .$$

The slope of a linear least squares fit provides the axis pitch (or roll), and the intercept provides the offset in center column (or row).

### Error Analysis

The following is an error analysis. It is based directly on the coordinate transformation equations detailed above, so it cannot be considered an independent check. The results are based on small value approximations. As a first approximation two axis values which add in quadrature phase (a cos x+b sin x) are simply combined in a single “average” term, and systematic errors (such as errors in determining the calibration parameters) are treated in the same manner as random errors (centroid measurement error, mechanical drift, inclinometer noise, etc).

An attempt is made to maintain consistent notation with the explanation of the coordinate transformation. For the simplified case with the inclinometer level, the variance in determining absolute azimuth is approximately:

$${σ}_{{ϕ}_{bt}^{′}}^{2} = {σ}_{{ϕ}_{b}}^{2} + {σ}_{{ϕ}_{t}^{′}}^{2} + ( {( \frac{1}{{θ}_{s}} )}^{2} + {( \frac{{\overline{α}}_{s}}{{sin}^{2} {θ}_{s}} )}^{2} ) {σ}_{{x}_{e}}^{2} + {( \frac{{\overline{α}}_{s}}{{sin}^{2} {θ}_{s}} )}^{2} ( {( \frac{Δ {x}_{e}}{Δ x} {θ}_{s} )}^{2} ) + {σ}_{{α}_{s}}^{2} {cot}^{2} {θ}_{s} + {( \frac{1}{{sin}^{2} {θ}_{s}} )}^{2} {σ}_{{θ}_{x}}^{2}$$

A brief summary of the terms is listed in Table 3.

TABLE 3
Summary of error contributions for leveled operation.

| | |
|---|---|
| (1) | σ_{φ}_{_{b}} = error in boresight azimuth calibration |
| (2) | σ_{φ}_{_{I}}^{_{′}} = error in calculated sun location in ENU frame. |
| | Time, geo-location, and ephemeris errors are all believed to |
| | be negligible. Error for |
| (3) | α̅ₛ = average of fisheye boresight angular offset from inclinometer |
| | z-axis |
| (4) | σₓ_{ₛ} = error in sun position on sensor (centroid accuracy based on |
| | radiometric SNR, gain variation, and image distortion). SNR |
| | contribution believed to be small (image ~3 pixels and camera gain, |
| | exposure time set to ~200 counts out of 255, noise measured < 1 |
| | bit rms). Gain variation not measured. Image distortion, especially for |
| | large zenith angles is under investigation. |
| (5) | $\frac{Δ {x}_{e}}{Δ x} = fractional error in pixel size ( based on linear fisheye$ |
| | $response , more generally ( \frac{Δ {x}_{e}}{Δ x} ) {θ}_{s} should be re \text{-} placed as systematic$ |
| | error in measuring zenith angle). Response nonlinearity suspected |
| | problem. Correction under investigation |
| (6) | σ_{α}_{ₛ} = error in determining fisheye boresight calibration parameters |
| | plus boresight drift (time/temperature). Fisheye boresight calibration |
| | long term repeatability under investigation. |
| (7) | σ_{θ}_{ₓ} = noise in inclinometer measurement. |

If the device is permitted to pitch and bank, there is an additional error term which is proportional to the magnitude of the pitch and/or bank of:

$$\frac{{σ}_{{ϕ}_{blin}^{′}}}{{θ}_{x}} \approx \frac{1}{{sin}^{2} {θ}_{s}} \sqrt{{σ}_{{x}_{s}}^{2} ( {( \frac{sin {θ}_{s} cos {θ}_{s}}{{θ}_{s}} )}^{2} + 1 ) + {σ}_{{α}_{s}}^{2} ( 1 + {cos}^{4} {θ}_{s} ) + {( ( \frac{Δ {x}_{e}}{Δ x} ) {θ}_{s} )}^{2}}$$

Where a contribution from the boresight zenith angle relative to inclinometer zenith has been omitted (assumed negligible). The reader should note that this corresponds to an rms value instead of the variance shown for leveled operation. All of the error terms are the same as described in Table 3 with the exception of, σ_{θx}, the inclinometer measurement error. For pitched/banked operation, the inclinometer measurement error now includes not only noise, but any gain or nonlinearity contributions.

In addition to the error sources discussed above, the measurements will have two additional error sources. The first is the accuracy of the reference points. The second is pointing the Vector 21 (˜1.2 mr reticule diameter). Current rough estimate is that these error sources are on the order of 0.5 mr rms.

Test data proving the accuracy of this embodiment utilized with the Victor 21 binoculars and with a theodolite is reported in parent patent application Ser. No. 12/283,785 which has been incorporated herein by reference.

Once the target is identified, additional software determines the orientation of the camera. Astronomical algorithms and celestial navigation software suitable for programming computer 22 is described and provided in several well-known texts including Astronomical Algorithms by Jean Meeus that is referred to in the Background Section. Once the camera orientation is known, the azimuth of the instrument is easily computed.

### Boresighting the Module with Other Instruments

Calibration of the module with other optical instruments requires a single calibration. A target at a knowrement is made. The azimuth reported by the celestial measurements is then rotated to agree with the other optical instruments.

### Calibration Module is Separate

As indicated in FIG. 8 the calibration module (including Ethernet PHY chip 70, 20 pin connector 72 and JTAG connector 68) is a separate module from the DPS Module 66 and circuit board and the optical components in order to minimize the size and weight of the celestial compass.

### Advantages and Limitations of the Celestial Compass

A principal advantage of use of the celestial compass as compared to a magnetic compass is that it can continuously measure absolute heading relative to the Earth's true north with accuracy of 1 mil without the use of pre-emplaced infrastructure and does not rely on the use of magnetic compass. However the celestial compass shown in FIGS. 1 through 9 has limitations:
a) It cannot operate in the presence of heavy clouds, fog, and smoke, and
b) It cannot operate when line of sight to the sun or moon is obscured by trees, buildings or other structures, for example, in urban environments.

### Inertial Navigation

One alternative to overcome these limitations Applicants have added an inertial navigation component developed at Innalabs Inc. with offices located in Dullas, Virgina and image-based navigation system for position and weapon attitude determination for indoor conditions developed by Evolution Robotics with offices located in Pasadena, Calif. The use of Innalabs component permits the minimization of the effect of environmental conditions and high angular motion rate on module performance. The use of Evolution Robotics image based navigation system permits determination of position and attitude during indoor exercises.

The memory-based optical navigation system includes a processor programmed with images of the environment where the training is to take place. Images of the environment recorded by a camera mounted on the rifle are analyzed with special algorithms by a computer processor which determines, from the camera images and the programmed images, the pointing direction of the rifle.

Embodiments of the present invention also include software permitting users to identify landmarks imaged by the camera and to determine directions to those landmarks from specific locations during cloudless periods and to use those landmarks and directions as references for determining rifle pointing directions when clouds obscure the sun or stars.

### Single Camera and Multiple Cameras

Embodiments of the present invention can be designed for daytime operation based on the location of the sun and other embodiments can be designed for operation based on the position of the moon, the stars and other celestial objects such as man-made satellites. Or as described above with respect to FIGS. 1 through 9 the embodiments can be designed to operate day and night using a single camera. Alternatively as described in some of the parent application more than one camera can be included with at least one camera designed for day-time use and at least one camera designed for night-time use.

Applicants' earlier versions of their celestial compass included separate optical sensors optimized for daytime and nighttime operation along with two small digital cameras and miniature optical lenses. However, to meet the size, weight, and power requirements for determining pointing direction for rifles, a single-sensor design is preferred. The challenge is that a very large sensor dynamic range of 10¹¹ to 10¹³ must be accommodated in order to measure the position of both the sun and stars. Exposure time and gain control generally provide for a range of approximately 10⁵ in illumination. To enhance the system's dynamic range, Applicants have developed the filter described above. The mechanical neutral density filter described above provides the dynamic range required for day/night operation. A motor inserts or removes the filter in about 1 second for day/night operation. The motor is approximately the same size as the fisheye lens. Focus maintained by using a very thin filter, such as 12 micron thick aluminized Mylar film, such that the change in focus is negligible when the filter is inserted. An alternative filter would be to use a glass filter with a transparent piece of glass adjacent to the filter glass. This second optic would maintain the optical path length, and would appear in the gap as the filter wheel rotates.

### Imbedded Micro-Processor

The estimated number of operations required for the daytime sensor to determine target azimuth by imaging the sun is 40 million operations per second. As explained above a preferred micro-processor that meets this requirement is the BlackFin embedded processor ADSP BF537 available from Analog Devices. This processor has many several advantageous features such as very low power consumption (400 mW), a small size in a mini BGA package, a very low cost (approx. $45 in small quantities), and a scalable family of pin- and code-compatible parts. The compatible parts allow the processor to fit the application without requiring major changes to either the hardware or the firmware.

### Inertial Navigation Component

The celestial and inertial measurements features of the present invention complement each other well. The celestial measurements are very accurate with essentially no drift over long intervals, but will only be available intermittently due to high sensor motion and environmental conditions. The inertial measurements have very high bandwidth and are accurate over short time periods, but suffer from drift over long time periods. The two are integrated in a typical Kalman filter architecture. All sensors (i.e. the optical sensor, the inclinometer, the inertial navigation component and the magnetic compass if one is used) feed data directly to the main processor. The main processor will implement a Kalman filter to optimally combine the inputs from all four sensors.

The Kalman filter will include estimates for the accelerometer gain and bias drift based on the GPS position updates, gyro gain and bias drift based on the magnetic compass and the celestial sensor, and magnetometer bias drift based on the celestial measurements. Since the celestial measurements constitute the most computationally intensive measurements, they will only be updated once every 10 seconds. In the interim, the celestial sensors will be put in standby mode, and the processor clock will be reduced to conserve power.

### Operation

In clear sky conditions day and night, the celestial direction components provides periodic precision azimuth measurements with respect to Earth's true north and provides periodic (every 10 seconds) updates to the Kalman filter. The module provides a key element to the initial alignment at start up. Based on celestial azimuth measurements, the Kalman filter estimates the magnetometer bias drift, as well as gyro gain and bias drift. This allows the module of the present invention to mitigate the errors related to the Earth's declination angle occurring over time. The inertial navigation components correct for rifle movement over short periods. Additionally, the 10-second updates eliminate errors associated with local magnetic disturbances. On the other hand, using inputs from the magnetometer, the effects of highly dynamic conditions on performance is mitigated. The inertial navigation components continuously measure the weapon's motion and provide that information to the processor where it is used to determine the aiming direction of the rifle.

### Partly Cloudy Skies

Best results from the celestial direction components are achieved on cloudless days and nights. However these components can function in partly cloudy sky conditions. Test results have demonstrated an RMS target azimuth error, for a clear day or night, of 0.1 mil, for a cloudy day of 0.753 mil, and for cloudy night of 0.75 mil.

When clouds, fog, or smoke interfere with celestial measurements using the celestial direction components, the inertial navigation components which includes continuous input from the magnetometer will serve as a “fly wheel” carrying the celestial fix forward and determining the weapon's orientation. However, even in this case, the input from the magnetometer will include corrections (based on the last available azimuth measurement from the celestial direction components) which permit mitigation of the errors caused by the Earth's declination angle and by large magnetic disturbances.

### Power Consumption

Finally, the above describe preferred embodiment has been designed for extremely low power consumption. Various modes of operation are provided: full sleep mode; ready, or stand-by, mode; and operational mode. In the stand-by mode, the microprocessor requires less than 1 mW.

### Cloudy Weather

As indicated above in connection with the description of preferred embodiments. The primary components of the present invention cannot function as desired in cloudy weather or in similar situations when the celestial objects are not visible to the system's sensors. For these reasons embodiments may be equipped with a backup digital magnetic compass.

This magnetic compass can be calibrated periodically using the features of the present invention and can take over when the heavens are obscured. Alternatively or in addition a miniature attitude and reference system such as the systems discussed in the background section of this specification may be added to allow the target information to be determined in the event that clouds obscure the celestial objects. Also when systems of the present invention is located at a particular location the precise location to a local landmark can be identified by the system and utilized to provide reference directions later in the event of cloudy weather. To utilize this feature an additional camera may be required to assure that an appropriate local landmark is in the field of view of system camera. Another alternative for direction determination when celestial objects are not visible is to include a sky polarization feature.

### Sky Polarization Feature

In order to characterize the polarization of sky light over any field of view utilizing intensity measurements, a minimum of three measurements may be required. As explained in the background section, during daytime the sky is polarized in circles around the sun even in cloudy consitions. Applicants have determined that at night the sky is similarly polarized around the moon. Typically polarization measurements of intensity are made after the light has been made to pass through a linear polarizing filter. In order to make many such measurements over a region of the sky, several methods have been utilized or proposed:
1. A telescope with a single-pixel intensity detector is scanned over the region of interest and a data taken for at least three orientations of an included polarizing filter at each position.
2. A telescope is scanned over the region of interest. The light from a telescope is split and directed to at least three single-pixel intensity detectors, each with a fixed polarizing filter oriented in an appropriate fashion.
3. A camera or a telescope with a focal plane array (FPA) detector is utilized with a rotating polarizing filter. At least three exposures, each with a different orientation of the polarizing filter are required to acquire the necessary data.
4. The light from a camera lens or telescope is split a delivered to three FPA's simultaneously. Each FPA has a fixed polarizing filter oriented in an appropriate fashion. Only one set of simultaneous exposures is required to collect data. Only one exposure is required to take data.
5. A single imaging camera or a telescope with a single FPA detector is used. Polarizing filters are associated with individual pixels of a focal plane array. At least three orientations are utilized, and only a fraction of the pixels (⅓ at most) records information for a specific orientation of the polarizing filter. Only one exposure is required to take data.

There are issues with most of the above schemes. The sun (and moon) is continually moving, as are clouds. In order to make accurate measurements, the sun (or moon) and the atmosphere must be effectively frozen. Schemes 1 & 2 are not preferred, as they generally are too slow. Scheme 3 can be made to work, if the exposures are made at video rates, although some change in cloud pattern could occur over the required three frames. This can be accomplished utilizing ferroelectric liquid-crystal modulators. These in general are associated with narrow operating bandwidth and cannot be made to function in the ultraviolet. There are issues with reproducibility of the polarization axis versus applied voltage at different temperatures. Scheme 4 avoids these issues, but at the cost of three cameras and three filters instead of one each. Therefore a system based upon scheme 4 is more expensive, bulkier and heavier and consumes more power. Scheme 5 avoids all of the previous issues, although the data for each polarization axis is sparser, and must be interpolated. Although in cloudy skies the degree-of-polarization pattern can be quite noisy, the direction-of-polarization pattern is always determined primarily by single Rayleigh scattering, and the pattern is smooth and predictable. Hence sparse data does not present a fundamental problem. Therefore, scheme 5 is the best.

### Imaging Sky Polarization Compass

An imaging sky polarization compass (ISPC) consists of five principal components:
A wide-angle or fisheye lens, or a simple aperture
A polarizing filter or filter array
A focal plane array sensor
An inclinometer to determine pointing of the optical axis of the lens with respect to zenith
A processor to control the camera, take the appropriate data and compute an azimuth

### Reference Images

The result of polarized light traversing complicated optics could be extremely difficult to accurately characterize. The optics could include numerous lenses and coatings with unknown manufacturing variations and defects. The light will pass through a polarizing filter at various angles with respect to the normal, and the properties of the polarizing filter will not be perfectly uniform. The focal plane array will have non-uniformities in the pixels. A simple way to circumvent these difficulties is the following. Reference images are recorded of the sun in a clear sky, at various zenith angles, using the ISPC. A reference angle-of-polarization (AOP) image is computed for each zenith angle and stored in a data base. The azimuth of the sun with respect to the ISPC is recorded with each reference image. The location of zenith in the AOP images is recorded with each reference image.

### In Use

In use, when a new image is recorded, the AOP image is computed and is compared to a reference AOP image with the same zenith angle. If necessary, the comparison reference AOP image is interpolated between two database images with zenith angles bracketing the zenith angle for the current data. Either the reference AOP image or the new AOP data image is mathematically rotated about zenith and the degree of correlation with the other used to determine the best match. The amount of rotation required to obtain the best match determines the azimuth offset of the current sun position from that of the sun in the reference image, and determines the azimuth of the ISPC.

Preferred embodiments of the present invention includes this hybrid azimuth sensing system will increase the availability of nonmagnetic highly accurate azimuth solution up to 85%; enabling operability to persist in cloudy skies, completely overcast conditions and conditions when a line-of-sight to the sun is obscured by trees, buildings, or other structures, and even when a forward observer operates in a hole with only a limited area of the sky available for viewing. Additionally, the hybrid north finding system will also provide accurate azimuth in twilight conditions during and after sunset and prior to and during sunrise, when celestial bodies are generally not visible. This capability is increasingly important in higher latitudes (i.e. polar regions) that experience much longer twilight hours.

Applicant's sky polarization north finding system mimics a similar solution exploited by nature. As explained in the background section of this application, many insects and animals are known to use the sky polarization pattern for navigation. The hybrid azimuth sensing system will use a low-cost in-house polarizer-on-pixel technology to enable two operational modes: i) celestial mode when the sun is above the horizon and an imaging sensor is able to record the sun images or when the moon and stars are visible at night and ii) polarization mode, when the sun cannot be imaged by the sensor due to adverse weather conditions, or because the line-of-sight to the sun is obscured by trees, buildings, or other structures. This technology will increase the availability of azimuth solution for worldwide weather up to 85%. The hybrid system achieves a compact and lightweight form factor by cleverly leveraging common hardware architectures, including a fisheye lens, processor and electronics board native to the Applicants' celestial compasses described in the parent applications listed in the third paragraph of this specification, for both the celestial and polarization-based north finding modules.

### Applicant's Experiments

Applicants' experiments hade demonstrated the imaging of bright stars in daytime using an infrared camera with a 50 mm lens, and azimuth sensing in overcast conditions using the novel sky polarization measurement technique. Although longer wavelengths such as short wave infrared can better penetrate clouds and smoke, the ability to image the sun and stars is effectively eliminated with significant levels of cloudiness. The sky polarization pattern, however, typically persists in completely overcast skies at a detectable level in the near ultraviolet spectral range. The sky polarization technique, demonstrated by Applicants exploits this very important phenomenon; enabling a path towards achieving an accurate all-weather azimuth solution.

By imaging a significant portion of the sky, the signal-to-noise ratio and thus the single measurement accuracy can be improved. In poor sky conditions, the optimal regions of the sky for polarization measurements are more likely to be interrogated with a large field-of-view. In cases with restricted access to the sky such as under canopies or in urban environments with tall buildings, a portion of the un-obscured sky is likely to be found.

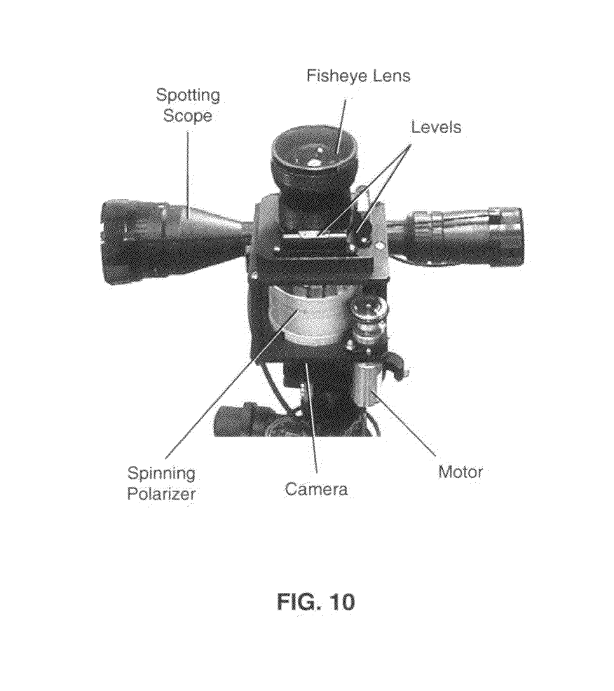

Applicants experiments have focused on developing and improving components for sky polarization measurements; culminating in a sensor system based upon a rotating polarizing filter with an optical encoder to keep track of the polarizer angle and trigger the camera at the appropriate times. FIG. 10 shows an experimental setup.

The sky polarization compass software developed by Applicants uses the current sky AOP pattern and a pattern matching algorithm to find the best reference image of the AOP with known sun azimuth and elevation angle stored in a digital library. The use of a pattern matching technique eliminates the need to take into account the effect of the optical system on the state of polarization detected at each pixel. The key steps of determining target azimuth using sky polarization compass are the following:
Record sky polarization images and create a digital library of wide angle AOP and DOP reference images under clear sky conditions for a range of solar elevation angles
Record sky AOP and DOP images for the current known location and time
Calculate the solar elevation angle for the current location and time
Select reference image data that matches the current solar elevation
Find the best match between the two images using the pattern matching algorithm
Calculate current azimuth position of the Sun relative to the Sun position at the time of the reference image
Calculate true North reference
Determine target azimuth.

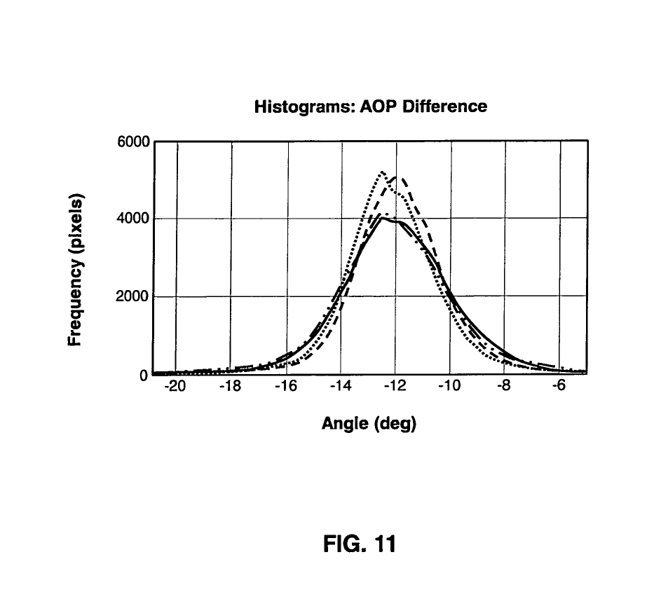

The rotating polarizer sky compass was demonstrated under various sky conditions. Sky images were taken for a fixed (standard) orientation of the system using a spotting scope pointing at a reference marker located about one-half mile across a canyon from the sky compass equipment. Polarization images and reference images were compared. FIG. 11 is an example showing histograms of the AOP diference between the polarization images and the reference images computed from the test data. Current single measurement azimuth accuracy in partly cloudy conditions is in the range from 0.1° to 0.3°. Under conditions when the line-of sight to the Sun was blocked by clouds or by a nearby object (building), the system performance is comparable to the clear sky conditions, 0.1°. System single measurement performance is typically in the range from 0.3 to 0.5 degrees under fully overcast sky conditions.

Applicants anticipate accuracy gains will be achieved by (ii) increasing the FOV up to 180 degrees, (ii) increasing system dynamic range from 8 bits to 12 bits, (iii) increasing camera frame rate up to 120 Hz and averaging of multiple measurements, and (iv) improving image quality metric used for “good” pixel selection based on Malus Law. The use of the Malus Law pixel filter qualifies image data inputs to the azimuth calculation to further increase confidence and accuracy.

Preferably miniature prototypes should incorporate polarizer-on-pixel technology in order to achieve size weight and power needs for appropriate to handheld applications, as well as to increase design robustness by eliminating moving parts. Ideally, the polarizers would be fabricated on the pixels at a foundry. However, this process is still in development and is too expensive to be a viable, near-term solution. For optimum extinction coefficient and transmission, the polarizers are ideally composed of high conductivity metal strips with a pitch significantly smaller than the wavelength of interest. In the near ultraviolet range (350 nm) this means line pitches of the order of a few hundred nanometers or less. CMOS devices generated by Mukul Sarkar used a line pitch of 0.48 micron and was actually inadequate for use in the near ultraviolet.

Alternately, Moxtek, Inc., with offices in Orem, Utah, has developed a process for depositing parallel aluminum nanowires onto glass substrates in intricate patterns and with pitch adequate for use to 300 nm wavelength. They can produce micro-polarizer arrays matching the pixel pitch of any focal plane array. These micro-polarizer arrays can be “glued” onto commercial off-the-shelf focal plane arrays (FPAs) to cost-effectively convert them to polarizer-on-pixel sensors. This is the preferred approach Applicants proposes for near term, low-cost polarizer-on-pixel sensors.

### Applications

The military uses compasses to determine the azimuth of surrounding locations and targets. However, conventional magnetic or digital-magnetic compasses are sensitive to the nearby presence of metals and alloys such as iron. However, much of military equipment, including vehicles, armament and weapons include such materials. Hence a non-magnetic compass is highly desired. The sky polarization compass is insensitive to the presence of magnetically active materials such as iron. By combining a sky polarization compass with GPS in a cell phone or other device containing a GPS receiver, the device becomes capable of pointing to known objects, or equally to displaying the azimuth of objects at which the device is pointed at. This could permit, for instance, a cell phone to point to the door of the emergency room, or any other known landmark. One could be guided more accurately and efficiently to a known destination, when the device can point. A backpacker in the Sierra mountain range could use a GPS receiver augmented with a sky polarization compass to determine which of the jagged points on a ridge, was actually Mount Whitney, and which gully is the Mountaineer's Route. All of this is possible, because the device can now accurately point to items of interest.

The imaging sky polarization compass can be used to determine the direction of zenith. The angle-of-polarization pattern in the sky is symmetric about the solar meridian, the plane containing the observer, the sun and zenith. Within this plane are two neutral points, the Arago and Babinet points, which are readily identifiable in the processed images. The positions of the two neutral points and the sun from zenith are all known, so if any of the three are visible, then the location of zenith is also determined. Hence the requirement of a separate inclinometer device to determine vertical is unnecessary. This might be particularly useful on moving platforms such unmanned aircraft, airplanes, boats, ground vehicles, missiles, etc, on which an inertial sensor for determination of vertical is difficult if not impossible.

The sky polarization compass uses knowledge of time and approximate position, along with sky polarization data to determine a very accurate value for the absolute azimuth of the device, and thus the absolute azimuth of surrounding objects and landmarks. It is possible to use the mechanism backwards to determine location. This could be advantageous, for instance, in a GPS denied environment. The direction of vertical can be determined either from the sky polarization pattern and the position of the sun or neutral point, or from an included inclinometer. The time could be determined using a clock of sufficient accuracy. The azimuth of the sun could be determined through the use of the sky polarization pattern in combination with the use of a conventional magnetic or digital-magnetic compass. With this data, geographic location can be determined.

It is possible to use the mechanism backwards to determine time. This could be advantageous, for instance, in a GPS denied environment. The direction of vertical can be determined either from the sky polarization pattern and the position of the sun or neutral point, or from an included inclinometer. The azimuth of the sun could be determined through the use of the sky polarization pattern in combination with the use of a conventional magnetic or digital-magnetic compass. If the geographic location is also known from topography or landmarks, then the time is determined.

Embodiments of the present invention include in many applications where high accuracy directional equipment is needed such as for use in surveying, on cruise ships, fishing boats and private and commercial aircraft. The invention may also be utilized on robotic vehicles including unmanned aerial vehicles, unmanned marine vehicles and unmanned surface vehicles. A particular important use of the invention will be as a guidance and control feature for robotic vehicles designed for use in dangerous situations where accurate directional information is required. For example, in addition to the telescopic equipment the celestial camera and the MEMS mirror of the present invention, the robotic surveillance vehicle could be equipped with a GPS unit, and a backup digital magnetic compass and a camera for monitoring the field of view of the telescopic equipment. Communication equipment would be needed for remote control of the robotic vehicle. Utilizing features described in the embodiments described above dangerous targets could be identified and neutralized. Embodiments could include weapons for defense or even offence which could be operated remotely.

### Test Results

Actual test results of prototype units confirm that the accuracy of Applicants compasses are about an order of magnitude better than magnetic compasses. As indicated in the Background section magnetic compasses under ideal magnetic conditions operate with a measurement error typically in the range of about 10 to 17 milliradians which results in a locator error of about 50 to 85 meters at a 5 km range. Applicants' celestial compasses (with the sun, moon or visible stars at least 45 degrees off zenith (vertical)) operate with an a measurement error in the range of about 1 to 2 milliradians which corresponds to a locator error of about 5 to 10 meters at the 5 km range.

There are many variations to the above specific embodiments of the present invention. Many of these will be obvious to those skilled in the art. For example in many embodiments focal plane arrays with only about 350,000 pixels will be adequate. Preferably time should be accurate to at least three seconds. For a less expensive system, the inertial navigation system and the memory-based navigation could be omitted. In this case the system would in general not be operative in cloudy weather. However, local landmarks that are visible to the camera could be substituted for celestial objects if the system is properly calibrated using celestial information to determine the position of the landmarks. Operators could also install a substitute landmark to use in this situation. These landmarks could also be used in the full system with the inertial navigation for re-calibration in the event of cloudy weather. So the scope of the present invention should be determined by the appended claims and their legal equivalence.

What is claimed is:

1. A celestial compass comprising:
A) a camera system adapted for viewing at least portions of the sky and comprising:
1) a telecentric fisheye lens,
2) a sensor having a focal plane array of at least 350,000 pixels, and
B) an inclinometer
C) a processor programmed with a celestial catalog providing known positions at specific times of at least one celestial object and algorithms for automatically calculating target direction information based on the inclination of the system as measured by the inclinometer and the known positions of at least two celestial objects as provided by the celestial catalog and as imaged by the camera,
D) a polarization filter or polarization filter array adapted to permit the camera system to measure polarization of light from a plurality of regions of the sky so as to determine location of at least one celestial object.

2. The compass as in claim 1 wherein the at least one celestial object comprises the sun and the moon.

3. The compass as in claim 1 wherein the at least one celestial object comprises the sun.

4. The compass as in claim 1 wherein the camera system also comprises a movable filter unit comprising an optical filter and adapted to block portions of sunlight to permit day time and night time operation of the kit with the single camera system;

5. The celestial compass as in claim 1 wherein the at least one celestial object is the sun, the moon and a plurality of stars.

6. The celestial compass as in claim 1 wherein the at least one celestial object is the sun, the moon a plurality of stars and at least one artificial satellite.

7. The celestial compass as in claim 1 wherein the filter unit includes an electromagnetic switch.

8. The celestial compass kit as in claim 1 wherein the filter unit includes an electric motor.

9. The celestial compass as in claim 7 wherein the electromagnetic switch is adapted to insert the filter between the lens and the sensor with current flowing in a first direction and to remove the filter with current flowing in a second direction opposite direction.

10. The celestial compass as in claim 1 wherein the telecentric lens is comprised of at least seven optical elements.

11. The celestial compass as in claim 1 wherein the processor is a dightal signal processor and further comprising other electronic components including:
A) a set of voltage regulators,
B) a JTAG interface,
C) an Ethernet PHY chip and
D) a multi-pin connector.

12. The celestial compass as in claim 1 wherein the compass is adapted to provide an RMS azimuth measurement error of less than 2 milliradians.

13. The celestial compass as in claim 1 wherein the compass is a component of a range finder.

14. The celestial compass as in claim 1 wherein the compass is a component of a gun.

15. The celestial compass as in claim 1 wherein the compass includes a backup magnetic compass.

16. The celestial compass as in claim 1 wherein the sensor is a CMOS array.

17. The celestial compass as in claim 1 wherein the sensor is a CCD array.

18. The celestial compass where the polarization filter or polarization filter array is a polarization filter array comprising wire-grid polarizers.

19. The celestial compass as in claim 18 wherein the wire-grid polarizers are deposited directly on CMOS or CCD pixels.

20. The celestial compass as in claim 18 wherein the wire-grid polarizers are comprised of aluminum wire grids.
